(19) United States
(12) Patent Application Publication
(10) Pub. No.: US 2003/0215175 A1
(43) Pub. Date: Nov. 20, 2003

(54) Method and apparatus for a field upgradable re-configurable optical add/drop switch

(76) Inventors: Tino Alavie, Thornhill (CA); Cyrus Etemad Moghadam, Richmond Hill (CA); Ming Gang Xu, Toronto (CA); Robert DeVries, Bolton (CA)

Correspondence Address: DOWELL & DOWELL PC, SUITE 309, 1215 JEFFERSON DAVIS HIGHWAY, ARLINGTON, VA, 22202

(21) Appl. No.: 10/387,474

(22) Filed: Mar. 14, 2003

Related U.S. Application Data
(60) Provisional application No. 60/364,038, filed on Mar. 15, 2002.

(51) Int. Cl. G02B 6/35; G02B 6/28

(52) U.S. Cl. 385/22; 385/24

(57) ABSTRACT

The present invention describes a method and devices for scaling the capability of a re-configurable add/drop multiplexer while not affecting the express traffic that goes through it. The invention allows field upgradability of re-configurable add/drop multiplexers with pre-selected wavelengths or wavebands such that other wavelengths or bands can be added or removed without service interruptions. This will then allow for a pay-as-you-grow model and therefore alleviate the need for having costly OADMs with a large number of addressable channels. In addition, in one of the embodiments we will describe a method for removing single point of failure through design, which is highly desirable from a network maintenance perspective.

### CROSS REFERENCE TO RELATED U.S. PATENT APPLICATION

This patent application relates to U.S. provisional patent application Serial No. 60/364,038 filed on Mar. 15, 2002 entitled METHOD AND APPARATUS FOR A FIELD UPGRADABLE RE-CONFIGURABLE OPTICAL ADD/DROP SWITCH.

### FIELD OF THE INVENTION

The present invention relates to a method and apparatus for a field upgradable re-configurable optical add/drop switch.

### BACKGROUND OF THE INVENTION

Dense wavelength division multiplexing (DWDM) fiber optic networks are significantly more efficient than traditional fiber networks that use a single transmitter detector pair in each fiber path. In DWDM networks many wavelengths of light, used as carriers of information, are multiplexed so that they are transmitted and received over the same fiber path. This significantly reduces the need for increasing costly fiber routes and thereby increases fiber throughput by many folds. One of the limitations of these lightwave networks, however, is their inability to perform functional tasks, such as switching and routing within the optical domain. In fact, most of these functions are now performed only after the signal carrying wavelengths have been separated and detected electronically. The lack of such functionalities within the optical domain has limited the penetration of DWDM technology in telecom and data networks so much so that they are primarily deployed in the backbone of large networks.

There are, however, significant benefits that would result by adopting photonics deeper into the network such that the transition between the core and the metro or the edge of a network would work more seamlessly with one another. This would then result in significant cost savings both from a deployment and a maintenance perspective. A re-configurable optical add/drop multiplexer (ROADM) would provide the flexibility necessary to drop and add an arbitrary set of wavelengths from an input set while leaving the remaining portion of the signal virtually untouched. Such a network element could be properly positioned to replace or augment electronics circuitry at a fraction of the cost at a switching or branching site.

Re-configurable add/drop multiplexers (switches) are typically designed to operate on a predetermined set of wavelengths or range of wavelengths. This poses, however, a challenge from a network architecture point of view in that designers are often left with the difficult choice of either locking their addressable wavelengths for specific sites to a predetermined set, or choosing a ROADM that is much larger than they may need at the time of deployment. Therefore, it is highly desirable that networks are designed so that their capacity can be upgraded with use. However, being locked into a specific set of addressable wavelengths that is either too small or too large may turn out to be too costly for network operators to bear.

### SUMMARY OF THE INVENTION

The present invention describes a method for scaling the capability of a re-configurable add/drop multiplexer while not affecting the express traffic that goes through it. In other words, using the stated approach will allow field upgradability of re-configurable add/drop multiplexers with pre-selected wavelengths or wavebands such that other wavelengths or bands can be added or removed without service interruptions. This will then allow for a pay-as-you-grow model and therefore alleviate the need for having costly OADMs with a large number of addressable channels. In addition, in one of the embodiments we will describe a method for removing single point of failure through design, which is highly desirable from a network maintenance perspective.

The present invention provides a re-configurable optical add/drop switch, comprising:

an optical branching means having an optical input and at least one optical output for respectively optically coupling light into and out of said optical branching means; and

a wavelength selective switchable filter means having a filter input and a filter output, a first multiport optical switch in switching relationship with said filter input and a second multiport optical switch in switching relationship with said filter output, said at least one optical output being optically coupled to said first multiport optical switch, wherein in one switch position said first and second multiport optical switches re optically coupled to said filter input and filter output respectively producing an optical path into said first optical switch through said wavelength selective switchable filter means and out of said second multiport optical switch, and in a second switch position said first and second multiport optical switches are optically coupled together thereby bypassing said wavelength selective switchable filter means.

In this aspect of the invention there may a second reflective wavelength selective switchable filter optically coupled between said at least one optical output and said first multiport optical switch.

In another aspect of the invention there is provided a re-configurable optical add/drop switch, comprising:

an optical branching member having an optical input and at least one optical output for respectively optically coupling light into and out of said optical branching member;

a wavelength selective switchable filter having a filter optical input and a filter optical output, said filter optical input being optically coupled to said at least one optical output, and

a first multiport optical switch in switching relationship with said optical input and a second multiport optical switch in switching relationship with said filter optical output, wherein in one switched position said first and second multiport optical switches are optically coupled to said optical input and filter output respectively producing an optical path into said first optical switch through said optical branching member and said wavelength selective switchable filter and out of said second multiport optical switch, and in another switched position said first and second multiport optical switches are optically coupled together thereby bypassing said optical branching member and said wavelength selective switchable filter.

In another aspect of the invention there is provided an optical device for splitting and recombining optical signals, comprising:

optical band splitting means for splitting an optical band input into said optical device into a pre-selected number N of optical sub-bands with each sub-band including a pre-selected number of wavelengths;

N re-configurable optical add/drop switches, each of said N optical sub-bands being optically coupled into an associated re-configurable optical add/drop switch as claimed in claims 1, 4 or 10; and

optical signal combining means for combining an output of each of said N re-configurable optical add/drop switches into an optical band output from said optical device.

### BRIEF DESCRIPTION OF THE DRAWINGS

The method of the present invention will now be described by way of example only, reference being had to the accompanying drawings in which:

FIG. 1 is a schematic diagram of an embodiment of a serial upgradeable ROADM constructed in accordance with the present invention in which the branching component is shared by both existing and upgradeable switchable gratings;

FIG. 2a is a schematic diagram similar to FIG. 1 but showing a serial upgradeable ROADM operating in the upgrade mode with a wavelength selective switchable filter inserted and engaged by the two multiport; switches;

FIG. 2b is a schematic diagram similar to FIG. 1 showing a serial upgradeable ROADM operating in the by-pass mode the same as in FIG. 1 where the multiport optical switches are connected in such a way as to bypass the a wavelength selective switchable filter;

FIG. 3 is a schematic diagram of a serial upgradeable ROADM produced by placing the branching component between two switches;

FIG. 4 is a schematic diagram another embodiment of a serial upgradeable ROADM is achieved by placing both existing and upgradeable modules (switchable gratings) between two optical switches;

FIG. 5 is a schematic diagram describing the wavelength banding concept;

FIG. 6 is a block diagram of an optical device architecture based on parallel upgradeable ROADM's using an ideal band splitter/combiner coupled with the upgradeable ROADM design of choice (as in FIGS. 1, 3, 4);

FIG. 7 shows the Transfer function of a non-ideal band splitter;

FIG. 8 is a schematic representation of a parallel upgradeable ROADM using a band cleanup filter (A2) such that a non-ideal band splitter/combiner can be used to achieve further band splitting/combining;

FIG. 9 is a schematic representation parallel upgradeable ROADM using non-ideal band splitter/combiner in conjunction with band stop filters; and

FIG. 10 is a perspective panoramic view of how optical backplane/connector and interlock switch is implemented.

### DETAILED DESCRIPTION OF THE INVENTION

Re-configurable Optical Add/Drop Muliplexers (ROADM) allow for extracting and inserting an arbitrary arrangement of wavelengths into a DWDM signal. These devices are generally used for designing flexible optical networks whereby wavelengths can be reassigned to support multiple paths. Most ROADMs are designed to operate on a specific part of the optical communication spectrum. In other words, these devices generally carve out a portion of the spectrum and allow switching of wavelengths in an arbitrary fashion within the partitioned spectra. The partition spectra can, in fact, be interpreted as a sub-band within a larger band. The premise of the present invention is to use a banded structure to allow insertion and extraction of sub-banded modules that address different parts of a larger spectrum without disturbing the flow of traffic, in the form of light, through it.

The present invention embodies the use of band splitting and combining in either a serial or parallel configuration, together with optical branching components, optical switches, and specialty connectors, to form a field upgradable re-configurable optical add/drop multiplexer. More specifically we make reference to copending U.S. patent application Ser. No. 10/193,686 (publication number US-2003-0016911-A1) incorporated herein by reference) whereby a multichannel switchable fiber grating is used in a variety of configurations to form a ROADM. The multichannel grating is designed to carve out a band of the spectrum such that a predetermined number of channels can be switched on or off within that band. Multiple switchable gratings, each covering a specific band, can be cascaded to cover a larger band. In this way, scalability is achieved by using the banded structure of the gratings itself. Although we are making reference to a particular design, this principle can be expanded to cover other approaches that inherently operate over a specific and finite band. In addition, various configuration of a ROADM described in U.S. patent No. 60/306,158 (incorporated herein by reference) can be used in conjunction with the present invention to offer more flexibility and functionality regarding field upgrade.

It is not desirable to break the path of light, inadvertently skip any channels, and more generally, alter the express path through an ROADM in any way. Therefore, the banded approach of choice must allow passing of all channels within each sub-band and disallow any channels from each adjacent sub-band. This is to ensure that no insertion loss penalties or other undesirable effects occur which could otherwise result by using non-ideal filter shapes.

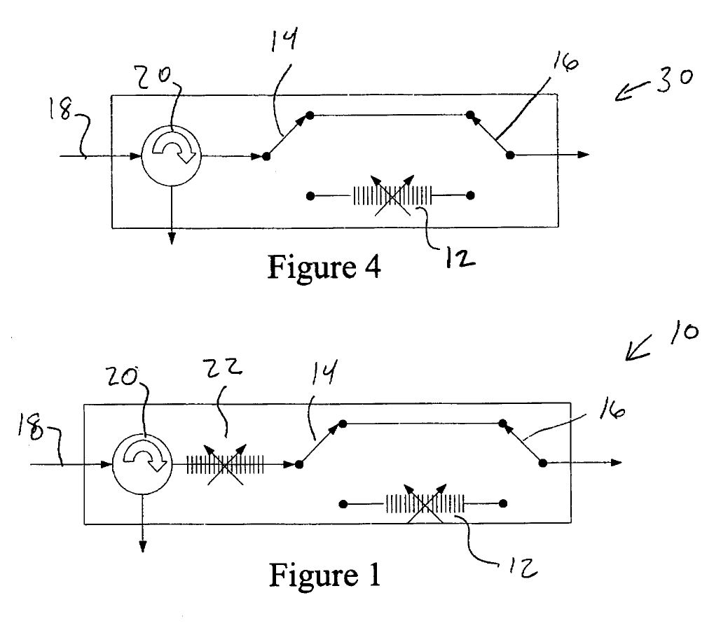

In the present invention using a serial design approach, the present field upgradable ROADM shown generally at 10 is constructed by placing the switchable grating 12 between a set of two multiport optical switches 14 and 16 as shown in FIG. 1. Light from the input port 18 enters a branching component, in this case an optical circulator 20, and passes through an existing switchable grating 22 and the two 1×2 optical switches 14 and 16 that have been connected via optical backplane connectors. Individual or a group of pre-assembled switchable gratings, in the form of pluggable modules, can then be inserted in between two corresponding switch ports 14 and 16 so as to create an upgrade on an existing number of channels or revert into a bypass mode as appropriate.

FIG. 2a shows a simplified upgradable ROADM in upgrade mode and FIG. 2b shows the simplified upgradable ROADM in by-pass mode. Referring to FIGS. 2a and 2b, the intent is to provide an electrically hot swappable slot in a card cage to allow a module to be inserted into a shelf with blind mate electrical and optical connectors. The slot 40 electronically recognizes that a module 42 has been inserted into the slot, as in FIG. 2b, and switches the optical signal from the by-pass feed-through mode to the upgraded module 42 when appropriate. Optical switches connected to the upgraded slot 40 in FIG. 2b through an optical backplane connector 44 allows for the optical connection to be kept intact throughout the upgrading process.

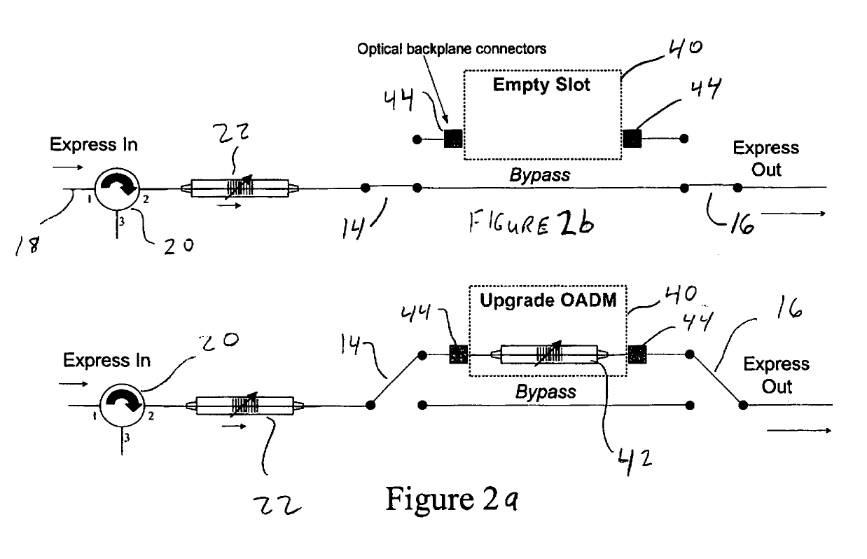

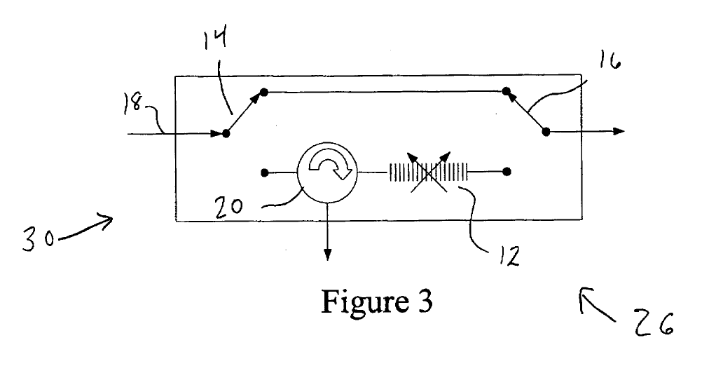

Referring to FIG. 3, in an alternative embodiment of the upgradable ROADM shown generally at 26, a slight modification of the serial architecture of FIG. 1 may be effected by placing the branching component 20 inside the pair of switches 14 and 16. This architecture has the added benefit that the drop port loss is reduced because the reflected (dropped) light does not pass through the switch twice as was the case with the design of FIG. 1. FIG. 4 shows an alternative embodiment at 30 which is a variation on the device 26 shown in FIG. 3, where the branching component, the circulator 20 in this case, is shared amongst all the switchable gratings. This includes the existing and any upgrades.

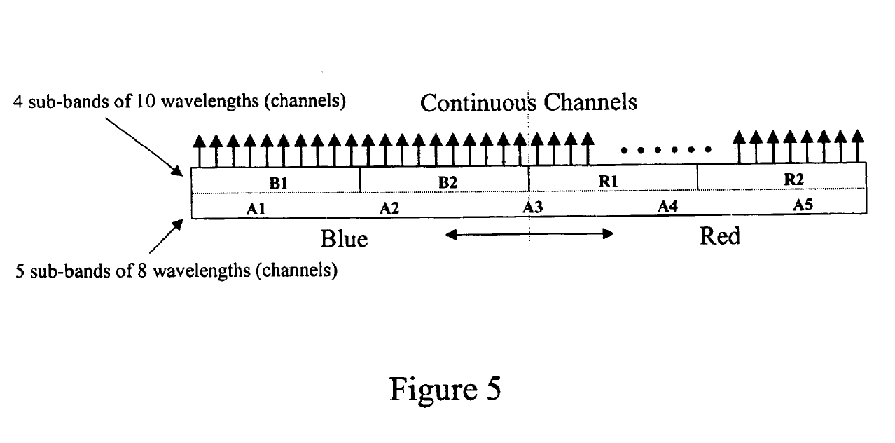

The parallel architecture uses band splitting and combining to separate the optical path of upgrade modules. In its most generic design, the overall band is first split into two bands of red and blue and then further split into four bands of two red and two blue as shown in FIG. 5. Each sub-band is then assigned one upgrade module with a specific set of wavelengths to operate. This then allows the design of a field upgradable system such that modules of separate bands could be inserted or removed without affecting other bands or the express traffic.

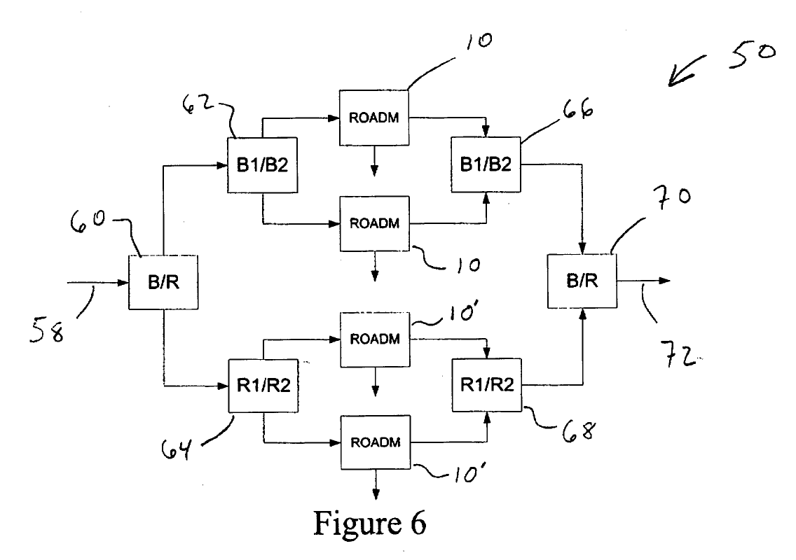

FIG. 6 is a block diagram of an optical device architecture shown generally at 50 based on parallel upgradeable ROADM's using an ideal band splitter/combiner coupled with the upgradeable ROADM design of choice (as in FIGS. 1, 3, 4). More particularly, FIG. 6 shows a diagram of the design with the input light entering into a band splitter 60 through the input fiber 58 such that the input spectrum is split into two bands of red and blue each exiting a different fiber. The blue and red bands are further subdivided using band splitters 62 and 64 respectively so that each of the blue and red bands are divided into two sub-bands of red, namely R1 and R2 and two sub-bands of blue, namely B1 and B2. The sub-bands B1 and B2 then exit band splitter 62 through a different output fiber with each output fiber being directed into a different ROADM 10 (such as that shown in FIG. 1, FIG. 3, and FIG. 4) which is a multichannel switchable grating. Similarly, the sub-bands R1 and R2 exit band splitter 64 through a different output fiber with each output fiber being directed into a different ROADM 10′ which is also a multichannel switchable grating.

The express output of each ROADM 10 is connected to the two inputs of a band combiner 66 and the output of each ROADM 10′ is connected to the two inputs of a band combiner 68. The outputs of band combiners 66 and 68 are input to a band combiner 70 where the function of the band combiners is the opposite of the function of the band splitters. In other words, the band combiner 66 is used to multiplex B1 and B2 and band combiner 68 is used to multiplex R1 and R2. The two bands, red and blue are finally combined through the final stage combiner 70 and exit the system through an output fiber 72. This arrangement then allows field upgradability by operating independently each upgradable ROADM 10 or 10′.

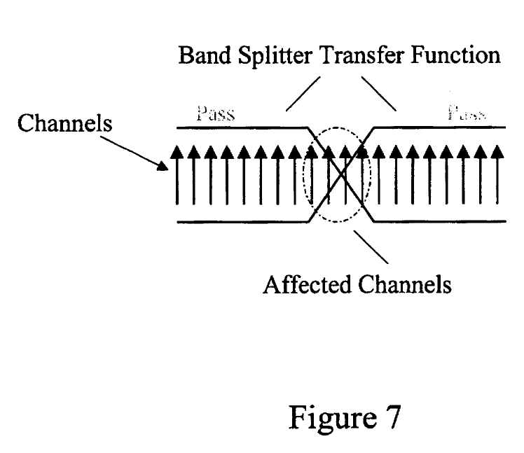

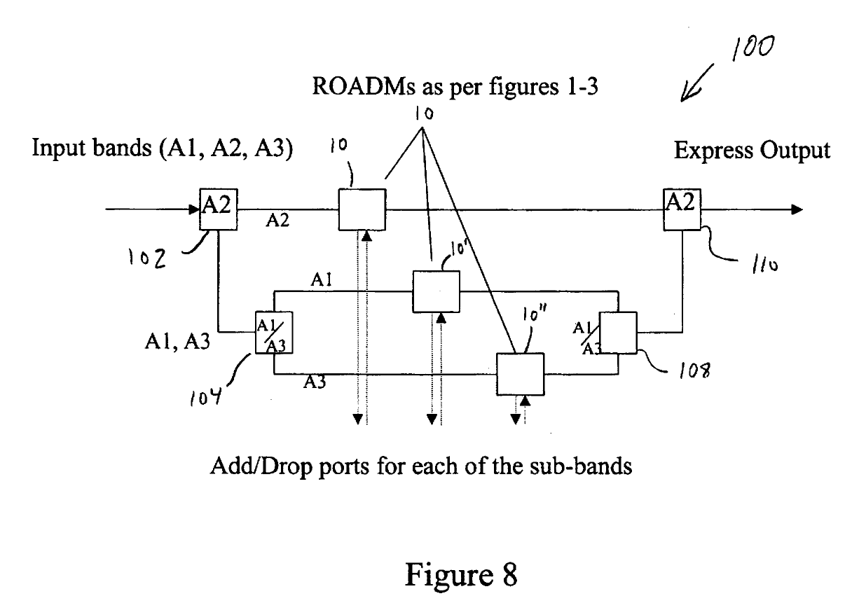

Most band splitters and combiners have a slope in their transfer function such that the roll-off of the filter as shown in FIG. 7 affects one or more of the boundary channels. To overcome such limitations, it is possible to use the multichannel switchable grating itself or some other means for initially removing those channels. The removed channels can subsequently be added back so as to keep the original signal integrity. This then has the benefit that no channels are eliminated or rendered useless as a result of employing a banded architecture.

In a general case of the parallel approach using band splitting, the spectral band of interest is subdivided into several bands. In order to alleviate the challenge in making filters with steep-edge transfer functions, as was described above, the bands are separated in a manner such that a middle band is removed prior to splitting its two adjacent bands. This methodology can be applied to any number of bands or channels within such bands. In other words, the bands can be made up of several channels or single channel if appropriate. The goal is to separate the bands into different fibers so that they can be operated on in a banded fashion by the ROADM and at the same time alleviate the difficulties associated with making band splitters and combiners that have near square transfer functions.

As an example of this approach, the multichannel switchable grating based ROADM (copending patent application Ser. No. 10/193,686 (publication number US-2003-0016911-A1) incorporated herein by reference) can be used in a judicious manner so as to separate every other sub-band and thereby allow the use of non-ideal filters on the remaining sub-bands. An example of this configuration is shown at 100 in FIG. 8 which shows a schematic representation of a parallel upgradeable ROADM using a band cleanup filter (A2) such that a non-ideal band splitter/combiner can be used to achieve further band splitting/combining. More particularly, in such an optical circuit 100, assuming a banded structure comprised of three separate bands A1, A2 and A3, for instance, the middle band A2 is removed in band splitter 102 such that the there is sufficient spectral separation for the two remaining bands A1 and A3 to be further separated in band splitter 104 without affecting any of the remaining channels in bands A1 and A3. Each of the separate bands is then inputted into a ROADM such as shown in FIGS. 1, 3 or 4. Recombination of sub-bands A1, A2 and A3 is accomplished by combining the outputs of ROADM 10′ and 10″ in a combiner 108 and combining the output of combiner 108 with the output of ROADM 10 in combiner 110. In this case it is noted that the size and number of the bands need not be limited to the example here and, in fact, can be interpolated to a larger or smaller number.

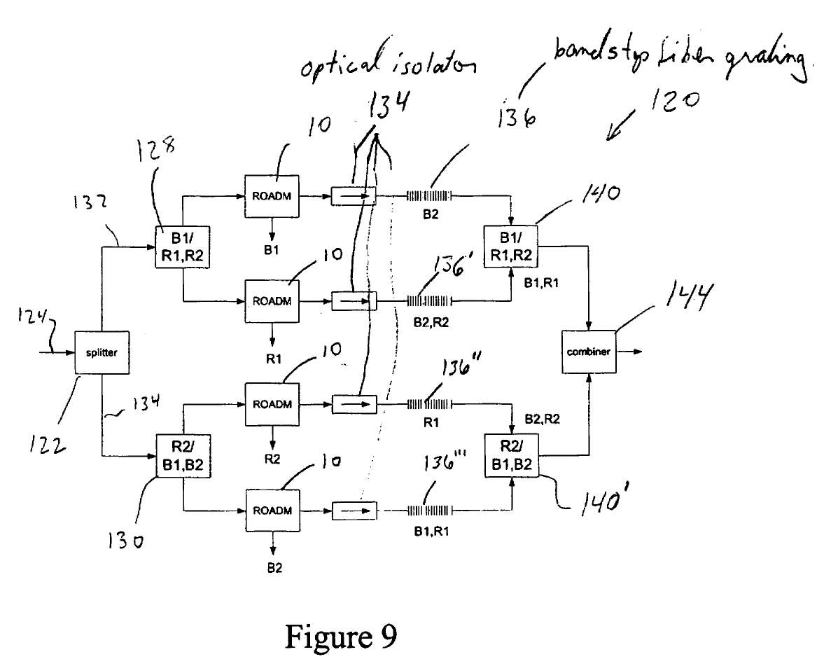

FIG. 9 is a schematic diagram of another embodiment of this invention shown generally at 120, in which an optical splitter 122 is used to first replicate the input signal on input fiber 124. Band splitters 128 and 130 are then used in each of the output arms 132 and 134 respectively to separate the respective input signals into two different sub-bands. For example, in the four-banded architecture of FIG. 9, the band splitter 128 is chosen such that it cleanly separates bands B1, R1, and R2 while affecting band B2 through its transition (non-ideal transfer function). The output from each arm of each of the band splitters can then be connected to a banded ROADM 10 such that only one of the two bands at its input is addressed. The other band is expressed through to its output through an optical isolator 134 after which where it is blocked by a band stop filter 136 (136′, 136″, 136′″). In this case, this band stop filter is comprised of a fiber Bragg grating 136 that operates on B2 in one arm and a fiber Bragg grating 136′ that operates on B2 and R2 in the other together with an optical isolator. This arrangement is repeated for each arm of the optical splitter and subsequent band splitter until all bands of interest are individually addressable. The signals expressed through from adjacent ROADM's from top to bottom in FIG. 9 are combined into combiners 140 and 140″ and the combined sub-bands from these two combiners are in turn combined in combiner 144, the output of which represents the recombined optical signals which are then forwarded along the optical circuit. This design is similar to those discussed above with the exception that it relies on duplicating the input optical signal and using a combination of band splitting and band stopping to achieve complete isolation of each band.

In the serial or parallel approach, electrical recognition of the upgrade slot can be achieved via an interlock switch (short throw, faceplate mounted) or a reduced length pin in the backplane. If a module is inserted in the upgrade slot, the module is recognized, and the system can switch to the upgraded module when appropriate (automatically). If a module is removed, the electrical open warns the system that the module is being removed. Switches automatically revert to the bypass route. The optical backplane connectors are usually designed to allow for float in the insertion direction (approximately 6 mm). Electronics are fast enough that if the module is being removed, optical connection in the upgrade slot is maintained well past optical switching.

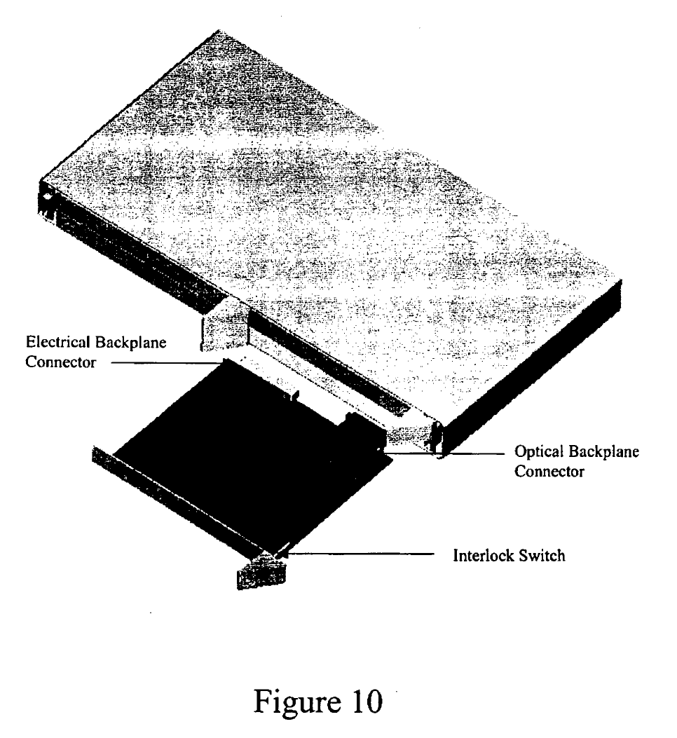

FIG. 10 shows a 3D concept of the hot swappable module with its optical, electrical daughter card interfaces and an interlock switch on the faceplate. When the module is inserted in the slot, electrical and optical connectors plug into their mates in the backplane. Optically, the signal is bypassed until the processor recognizes that the module has been inserted. Recognition is achieved via an interlock switch (short throw, with plunger against the ejector). When the switch plunger is pressed in, the electrical signal changes from on to off (or vice versa) and electronics can recognize that the module is being inserted. When the module is being removed, the switch polarity changes and the electronic circuit switches the signal optically. The same can be achieved with short pins in an electrical connector with connection on/off providing feedback to the electronics that the module is being removed or installed. Optical connection is maintained through the module removal process because optical backplane connectors are designed to have float in the insertion direction that is longer than the pins or the electrical interlock switch need. Electronics command switching faster than the module can be removed.

The design of the actual ROADM as it relates to the banded structure for an upgradeable composite device need not be limited to that of FIG. 1. In fact, the circulator and reflective wavelength selective fiber grating filter combination as shown in FIGS. 1 to 4 may be replaced with an optical branching element and one or more wavelength selective switchable filters in its most general case. In addition, it is equally inventive to use an optical branching component together with one or more reflective wavelength selective switchable filters to be able to construct a field upgradeable ROADM. If the optical branching element is an optical coupler, the wavelength selective switchable filter may be transmissive or reflective. It can be a fiber Bragg grating or other types of filter.

A wavelength selective switchable filter may be constructed with an optical dispersive element whose output (the dispersed light) falls on a target made up of an array of either liquid crystal switches or micro electromechanical switches. In addition, the same device, for instance could be made by cascading a number of Mach-Zehnder type interferometers whose arms are well balanced. Individual gratings are written into each arm of the Mach-Zehnder and may be de-tuned using controlled temperature variations to obtain swichability.

As used herein, the terms “comprises” and “comprising” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims.

Therefore what is claimed is:

1. A re-configurable optical add/drop switch, comprising:
an optical branching means having an optical input and at least one optical output for respectively optically coupling light into and out of said optical branching means;
a wavelength selective switchable filter means having a filter input and a filter output, a first multiport optical switch in switching relationship with said filter input and a second multiport optical switch in switching relationship with said filter output, said at least one optical output being optically coupled to said first multiport optical switch, wherein in one switch position said first and second multiport optical switches re optically coupled to said filter input and filter output respectively producing an optical path into said first optical switch through said wavelength selective switchable filter means and out of said second multiport optical switch, and in a second switch position said first and second multiport optical switches are optically coupled together thereby bypassing said wavelength selective switchable filter means.

2. The re-configurable optical add/drop switch according to claim 1 wherein said optical branching member is an optical circulator, and wherein said wavelength selective switchable filter is a reflective wavelength selective switchable filter.

3. The re-configurable optical add/drop switch according to claim 2 wherein said reflective wavelength selective switchable filter is a switchable fiber Bragg grating.

4. The re-configurable optical add/drop switch according to claim 3 including a second reflective wavelength selective switchable filter optically coupled between said at least one optical output and said first multiport optical switch.

5. The re-configurable optical add/drop switch according to claim 4 wherein said second reflective wavelength selective switchable filter is a switchable fiber Bragg grating.

6. The re-configurable optical add/drop switch according to claim 1 wherein said wavelength selective switchable filter is mounted on a module which is pluggable into a slot adapted to receive said module and wherein when said module is inserted into said slot said wavelength selective switchable filter is in optical switching engagement with said first and second multiport optical switches.

7. The re-configurable optical add/drop switch according to claim 6 wherein each of said first and second multiport optical switches include an optical backplane connector, and wherein said filter input engages one optical backplane connector and said filter output engages the other backplane connector when said module is plugged into said slot.

8. The re-configurable optical add/drop switch according to claim 1 wherein said optical branching member is an optical coupler, and wherein said wavelength selective switchable filter is a transmissive or wavelength selective switchable filter.

9. The re-configurable optical add/drop switch according to claim 8 wherein said wavelength selective switchable filter comprises an optical dispersive element having a dispersed light output incident on one of an array of iquid crystal switches and an array of micro electromechanical switches.

10. A re-configurable optical add/drop switch, comprising:
an optical branching means having an optical input and at least one optical output for respectively optically coupling light into and out of said optical branching means;
a wavelength selective switchable filter having a filter optical input and a filter optical output, said filter optical input being optically coupled to said at least one optical output, and
a first multiport optical switch in switching relationship with said optical input and a second multiport optical switch in switching relationship with said filter optical output, wherein in one switched position said first and second multiport optical switches are optically coupled to said optical input and filter output respectively producing an optical path into said first optical switch through said optical branching member and said wavelength selective switchable filter and out of said second multiport optical switch, and in another switched position said first and second multiport optical switches are optically coupled together thereby bypassing said optical branching member and said wavelength selective switchable filter.

11. The re-configurable optical add/drop switch according to claim 10 wherein said optical branching member is an optical circulator, and wherein said wavelength selective switchable filter is a reflective wavelength selective switchable filter.

12. The re-configurable optical add/drop switch according to claim 11 wherein said reflective wavelength selective switchable filter is a switchable fiber Bragg grating.

13. The re-configurable optical add/drop switch according to claim 10 wherein said optical branching member is an optical coupler, and wherein said wavelength selective switchable filter is a transmissive or wavelength selective switchable filter.

14. The re-configurable optical add/drop switch according to claim 13 wherein said wavelength selective switchable filter comprises an optical dispersive element having a dispersed light output incident on one of an array of iquid crystal switches and an array of micro electromechanical switches.

15. The re-configurable optical add/drop switch according to claim 10 wherein said wavelength selective switchable filter is mounted on a module which is pluggable into a slot adapted to receive said module and wherein when said module is inserted into said slot said wavelength selective switchable filter is in optical switching engagement with said first and second multiport optical switches.

16. The re-configurable optical add/drop switch according to claim 15 wherein each of said first and second multiport optical switches include an optical backplane connector, and wherein said filter input engages one optical backplane connector and said filter output engages the other backplane connector when said module is plugged into said slot.

17. An optical device for splitting and recombining optical signals, comprising:
optical band splitting means for splitting an optical band input into said optical device into a pre-selected number N of optical sub-bands with each sub-band including a pre-selected number of wavelengths;
N re-configurable optical add/drop switches, each of said N optical sub-bands being optically coupled into an associated re-configurable optical add/drop switch as claimed in claim 1; and
optical signal combining means for combining an output of each of said N re-configurable optical add/drop switches into an optical band output from said optical device.

18. The optical device according to claim 17 wherein said optical band splitting means includes a cascaded series of optical band splitters, and wherein said optical signal combining means includes a cascaded series of optical signal combiners cascaded in an opposite direction as said cascaded series of optical band splitters.

19. The optical device according to claim 18 wherein each optical band splitter has an optical input and two optical outputs for receiving a band of optical signals and splitting said band of optical signals into two sub-bands which are output on the two optical outputs.

20. The optical device according to claim 18 wherein each optical signal combiner includes two optical inputs for receiving two sub-bands of optical signals and an optical output for outputting the two combined sub-bands.

21. The optical device according to claim 19 wherein said optical signals input into, and output from, said optical band splitters, re-configurable optical add/drop switches optical signal combiners propagate in optical fibers which are optically coupled thereto.

22. An optical device for splitting and recombining optical signals, comprising:
optical replicating means for replicating an optical band into at least two substantially identical optical bands;
optical band splitting means optically coupled to said optical replicating means for splitting each of said substantially identical optical bands input into a pre-selected number N of optical sub-bands;
N re-configurable optical add/drop switches, each of said N optical sub-bands being optically coupled to an associated re-configurable optical add/drop switch as claimed in claims 1, 4 or 10; and
optical signal combining means for combining an output of each of said N re-configurable optical add/drop switches into an optical band output from said optical device.

23. The optical device according to claim 22 wherein said re-configurable optical add/drop switches includes an optical isolation means optically coupled thereto and a bandstop grating means for attenuating selected wavelengths propagating therethrough.

24. The optical device according to claim 22 wherein said optical band splitting means includes a cascaded series of optical band splitters, and wherein said optical signal combining means includes a cascaded series of optical signal combiners cascaded in an opposite direction as said cascaded series of optical band splitters.

25. The optical device according to claim 24 wherein each optical band splitter has an optical input and two optical outputs for receiving a band of optical signals and splitting said band of optical signals into two sub-bands which are output on the two optical outputs.

26. The optical device according to claim 24 wherein each optical signal combiner includes two optical inputs for receiving two sub-bands of optical signals and an optical output for outputting the two combined sub-bands.
